(19) United States
(12) Patent Application Publication
(10) Pub. No.: US 2026/0054633 A1
(43) Pub. Date: Feb. 26, 2026

(54) HYDRAULIC TOW TRUCK ANCHOR SYSTEM

(71) Applicant: Robert Lackey, Aurora, CO (US)

(72) Inventor: Robert Lackey, Aurora, CO (US)

(21) Appl. No.: 18/814,537

(22) Filed: Aug. 25, 2024

(51) Int. Cl. B60P 3/075

(52) U.S. Cl. CPC B60P 3/075

(57) ABSTRACT

A hydraulic tow truck anchor system includes a plurality of anchor assemblies, a hydraulic pump system, and a control arrangement. The anchor assemblies are mountable to a bed of a flatbed tow truck and detachably connect to a portion of a vehicle to temporarily secure the vehicle to the bed. The anchor assemblies each include a hydraulic cylinder and piston, an engagement head attached to and movable by the piston to place the piston in a securing engagement with a portion of a vehicle, and a pivoting assembly connected to the hydraulic cylinder to pivot the hydraulic cylinder between a vertical active position and a horizontal storage position. The hydraulic pump system is operatively connected to the hydraulic cylinders. The control arrangement is installable in a flatbed tow truck cab and operatively connected to the anchor assemblies and the hydraulic pump system to permit remote operation of the anchor assemblies.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle towing systems and more particularly pertains to a new hydraulic tow truck anchor system for allowing an operator of a tow truck, in particular a flatbed tow truck, to load a vehicle, such as a car or truck, onto the flatbed and secure the vehicle in place remotely from the cab of the flatbed tow truck.

### (2) Description of Related Art Including Information Disclosed Under 37 CFR 1.97 and 1.98

The prior art relates to vehicle towing systems. The prior art, as best understood, discloses systems in which the driver or operator must exit the cab and manually engage locking systems with the wheels or structural portions of the frame of a vehicle, which uses additional time and possibly exposes the driver to danger if the tow occurs on or near a road or highway. The prior art, as best understood, does not disclose a hydraulic tow truck anchor system that includes a plurality of anchor assemblies, a hydraulic pump system, and a control arrangement, wherein the anchor assemblies are mounted in the flatbed of a flatbed tow truck and each include a hydraulic cylinder and piston, and wherein an engagement head is attached to and movable by the piston to place the piston in a securing engagement with a portion of a vehicle, and wherein the control arrangement is installable in a cab of a flatbed tow truck and operatively connected to the anchor assemblies and the hydraulic pump system to permit a driver to remotely operate the anchor assemblies.

### BRIEF SUMMARY OF THE INVENTION

An embodiment of the disclosure meets the needs presented above in a hydraulic tow truck anchor system generally comprising a plurality of anchor assemblies, a hydraulic pump system, and a control arrangement. The anchor assemblies are designed to be mounted to a bed of a flatbed tow truck and detachably connect to a portion of a vehicle to temporarily secure the vehicle to the bed. The anchor assemblies each include a hydraulic cylinder and piston, an engagement head attached to and movable by the piston to place the piston in a securing engagement with a portion of a vehicle, and a pivoting assembly connected to the hydraulic cylinder and designed to pivot the hydraulic cylinder between a vertical active position and a horizontal storage position. The hydraulic pump system is operatively connected to the hydraulic cylinders. The control arrangement is installable in a cab of a flatbed tow truck and operatively connected to the anchor assemblies and the hydraulic pump system to permit a driver to remotely operate the anchor assemblies.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a hydraulic tow truck anchor system according to an embodiment of the disclosure.

FIG. 2 is another side view of an embodiment of the disclosure.

FIG. 3 is a side view of an embodiment of the disclosure installed on a flatbed tow truck.

FIG. 4 is a side view of an embodiment of the disclosure in use.

FIG. 5 is a top view of an embodiment of the disclosure.

FIG. 6 is a diagram of components of an embodiment of the disclosure.

FIG. 7 is a side view of an alternative embodiment of the disclosure.

FIG. 8 is another side view of the alternative embodiment of the disclosure.

FIG. 9 is a side view of another alternative embodiment of the disclosure.

### DETAILED DESCRIPTION OF THE INVENTION

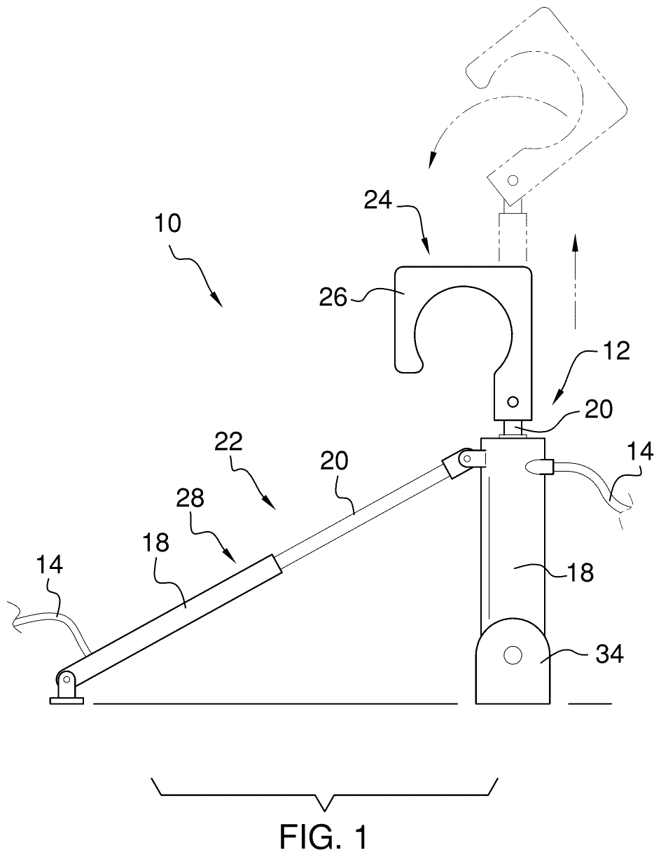

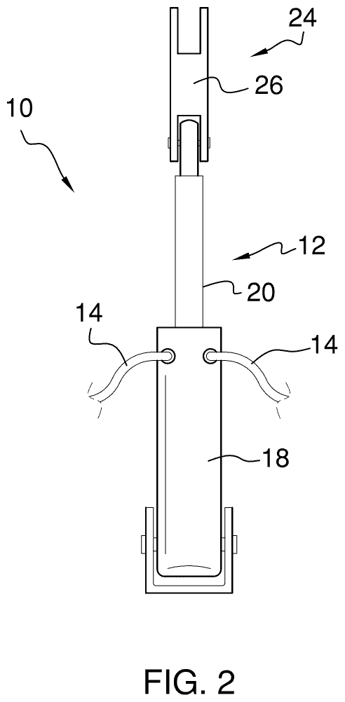

With reference now to the drawings, and in particular to FIGS. 1 through 9 thereof, a new hydraulic tow truck anchor system embodying the principles and concepts of an embodiment of the disclosure and generally designated by the reference numeral 10 will be described.

As best illustrated in FIGS. 1 through 9, the hydraulic tow truck anchor system 10 generally comprises a plurality of anchor assemblies 12, a hydraulic pump system 14, and a control arrangement 16. The anchor assemblies 12 are designed to be mounted to a bed 62 of a flatbed tow truck 60 and detachably connect to a portion of a vehicle 64 to temporarily secure the vehicle 64 to the bed 62. The anchor assemblies 12 each include a hydraulic cylinder 18 and piston 20, an engagement head 24 attached to and movable by the piston 20 to place the piston 20 in a securing engagement with a portion of a vehicle 64, and a pivoting assembly 22 connected to the hydraulic cylinder 18 and designed to pivot the hydraulic cylinder 18 between a vertical active position and a horizontal storage position. The hydraulic pump system 14 is operatively connected to the hydraulic cylinders 18. The control arrangement 16 is installable in a cab 66 of a flatbed tow truck 60 and operatively connected to the anchor assemblies 12 and the hydraulic pump system 14 to permit a driver to remotely operate the anchor assemblies 12.

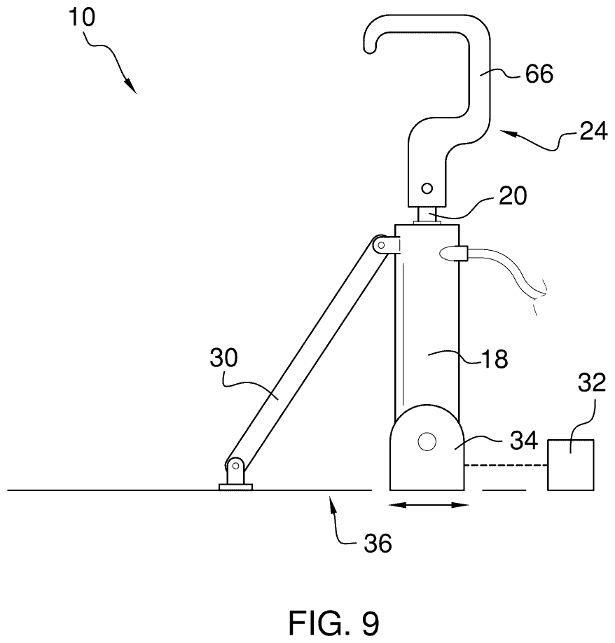

In the exemplary embodiment shown in FIGS. 1 through 5 and 9, the engagement head 24 includes a hook 26. The hydraulic cylinder 18 is designed to extend and retract the hook 26 to clamp onto an axle of a vehicle 64 with sufficient force to hold the vehicle 64 in place on a bed 62 of a flatbed tow truck 60. In the exemplary embodiment, the hook 26 is pivotably connected to the piston 20, though in another possible embodiment the hook 26 could be fixed, such as shown in FIG. 9, wherein the hook 26 is a J-hook.

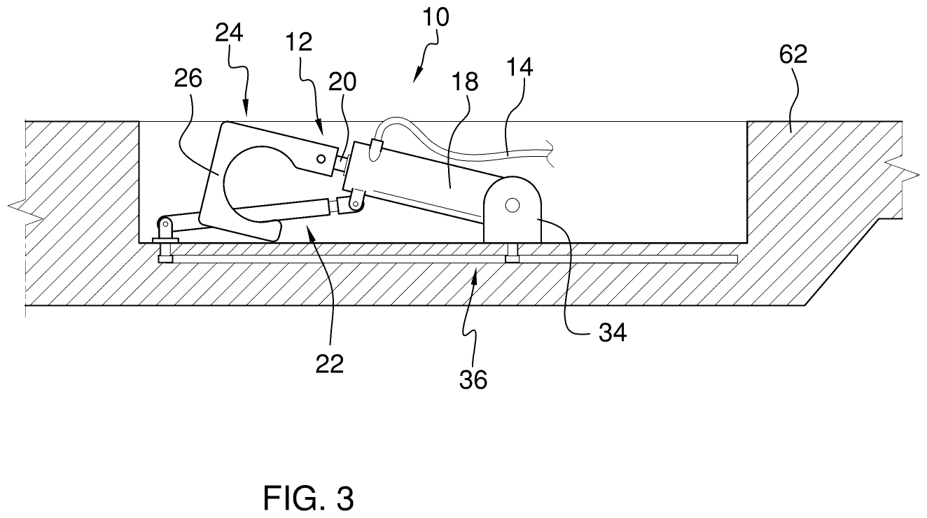

FIG. 1 shows the hydraulic cylinder 18 in the vertical active position, whereas FIG. 3 shows the hydraulic cylinder 18 in the horizontal storage position, wherein the anchor assembly 12 is stored in a recess in the bed 62 of the flatbed tow truck 60. In order to accomplish this movement, the pivoting assembly 22 can have a variety of different designs that are well known in the mechanical arts. For example, FIG. 1 shows a telescoping arm 28, such as another hydraulic cylinder 18 and piston 20, that is extendable and retractable. FIG. 9, for example, shows a fixed arm 30 in the form of a rod. Since fixed arm 30 has a set length, either the hydraulic cylinder 18 is movable back and forth by a drive unit 32 and the fixed arm 30 is in a stationary position, as shown in FIG. 9, or possibly the hydraulic cylinder 18 is stationary and the fixed arm 30 is movable. Each of the anchor assemblies 12 includes a mounting bracket 34 attachable to the bed 62 of the flatbed tow truck 60, wherein the hydraulic cylinder 18 is pivotably attached to the mounting bracket 34.

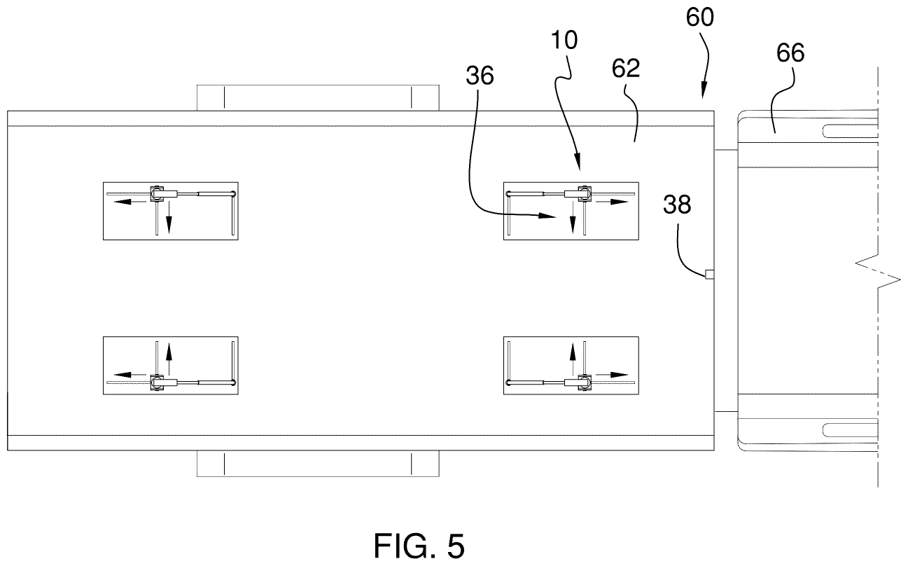

As best seen in FIG. 5, each of the anchor assemblies 12 includes a guide track and drive arrangement 36 mountable in the bed 62 of the flatbed tow truck 60 and operatively connected to the hydraulic cylinder 18 and the pivoting assembly 22 to permit selective adjustment of a position of the hydraulic cylinder 18 on the bed 62. For simplicity, the guide track and drive arrangement 36 is shown relatively schematically and operates according to known mechanical principles, wherein a structure, such as the mounting bracket 34, is movable along a guide track by a drive mechanism, such as the drive unit 32, which could be a screw drive, gear and chain, or belt system. The control arrangement 16 is operatively connected to the guide track and drive arrangement 36 to permit a driver to remotely operate the guide track and drive arrangement 36. This allows the driver to adjust the positions of the anchor assemblies 12 for different sizes of vehicles.

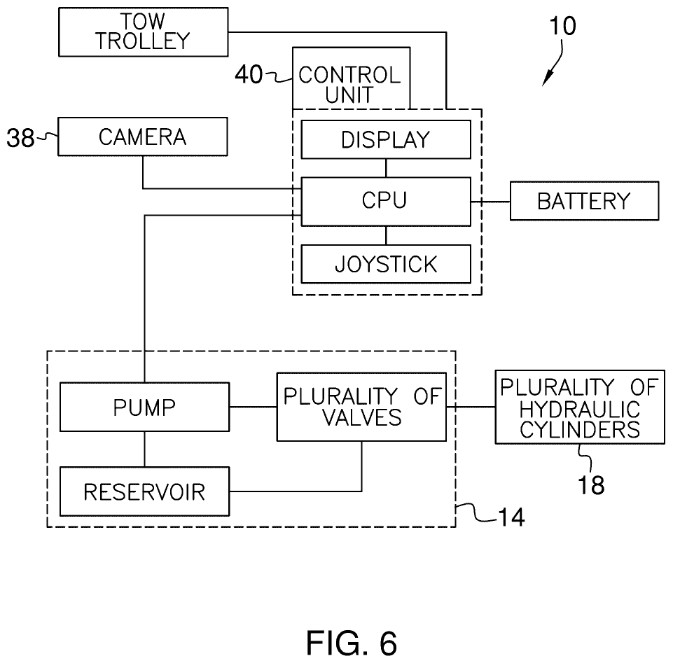

As shown in FIG. 5, the control arrangement 16 also includes a camera 38 mountable on the bed 62 of the flatbed tow truck 60 and a video screen (shown schematically in FIG. 6) mountable in the cab 66 of the flatbed tow truck 60 and operatively connected to the camera 38 to permit viewing of the anchor assemblies 12. As shown in the diagram in FIG. 6, a control unit 40, which is located in the cab 66 of the flatbed tow truck 60, can include the video screen or display, a computer processing unit (CPU), and a manual control, such as a joystick. Other manual controls could be included. The control unit 40 is operatively connected to a power source, such as a battery of the flatbed tow truck 60 or an additional battery. The camera 38 is operatively connected to the control unit 40. The control arrangement 16 is operatively connected to the hydraulic pump system 14, which could include standard components, such as a pump, a reservoir of hydraulic fluid, and a plurality of valves, operatively connected to the hydraulic cylinders 18 of the anchor assemblies 12. In one possible embodiment, the control arrangement 16 is operatively connected to a tow trolley to permit a driver to remotely operate the tow trolley to pull a vehicle 64 up onto the bed 62 of the flatbed tow truck 60. The tow trolley, as well as the components of the hydraulic system, are well-known and thus are only shown schematically. In one possible embodiment, an additional camera 38 could be installed on the tow trolley and operatively connected to the control unit 40.

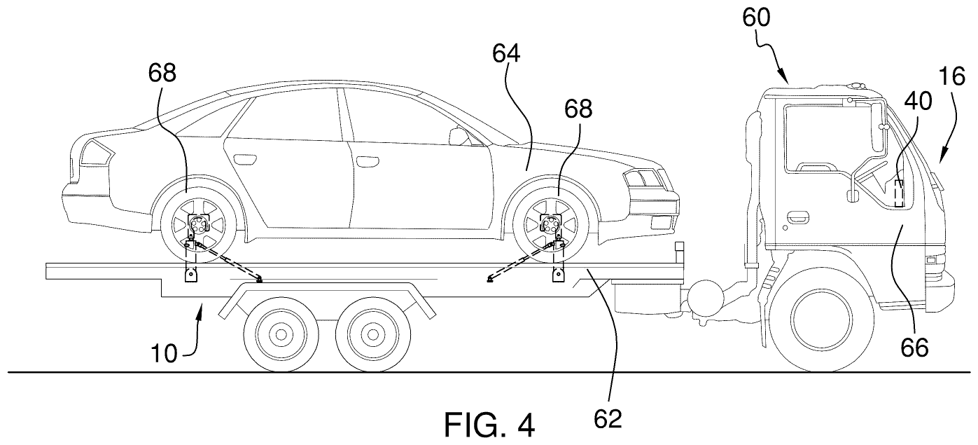

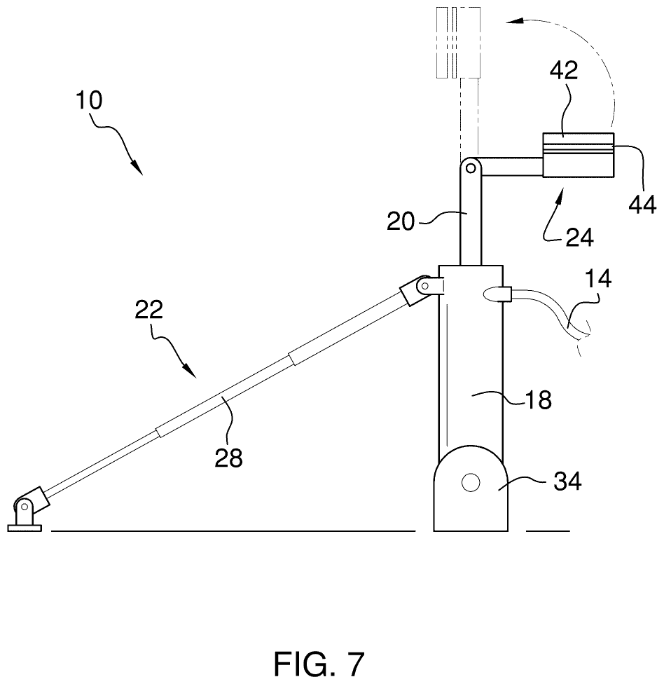

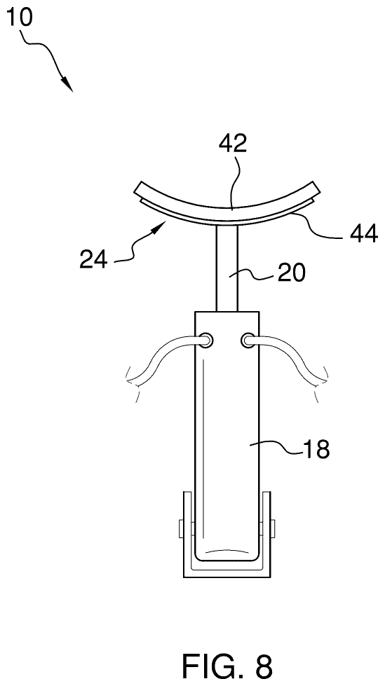

FIGS. 7 and 8 show an alternative possible embodiment, wherein the engagement head 24 includes a metal plate 42 and the hydraulic cylinder 18 is designed to extend and retract the metal plate 42 to place the metal plate 42 against a surface of a wheel 66 of a vehicle 64 with sufficient force to hold the vehicle 64 in place on the bed 62 of the flatbed tow truck 60. Therefore, instead of engaging the axle, as shown in FIG. 4, or a portion of the frame of the vehicle 64, the engagement head 24 presses against the exterior surface of a tire 68. The engagement head 24 includes a rubber layer 44 to cushion the metal plate 42 and thereby protect the tires 68 from damage. The engagement head 24 is pivotably connected to the piston 20, though it could be fixed.

To use the hydraulic tow truck anchor system 10, a driver positions the flatbed tow truck 60 in front of the vehicle 64. The driver then remotely operates the tow trolley to engage and pull the vehicle 64 up onto the bed 62 in a known manner. Once the vehicle 64 is on the bed 62 and adjacent the anchor assemblies 12, the driver positions the anchor assemblies 12 as needed. The driver then raises the hydraulic cylinders 18 to the vertical position and extends the piston 20 to place the engagement head 24 in a desired position. For example, as shown in FIG. 4, the hook 26 is placed above an axle of the vehicle 64. The driver then activates the hydraulic pump system 14 to cause the pistons 20 to retract and engage the hooks 26 on the axles, either simultaneously or individually. The hydraulic pump system 14 could be designed to exert a substantial force, such as approximately 300 to 600 PSI, to securely clamp the vehicle 64 in place on the bed 62. The driver can then tow the vehicle 64 to a desired location and then reverse the process to release and unload the vehicle 64. FIG. 4 shows the anchor assemblies 12 arranged such that the hydraulic cylinders 18 are on the outside of the axles of the vehicle 64. However, the hydraulic cylinders 18 could be placed on the inside, or some on the outside and some on the inside.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hydraulic tow truck anchor system comprising:
a plurality of anchor assemblies configured to be mounted to a bed of a flatbed tow truck and detachably connect to a portion of a vehicle to temporarily secure the vehicle to the bed, wherein each of said anchor assemblies comprises:
a hydraulic cylinder and piston,
an engagement head attached to and movable by said piston to place said piston in a securing engagement with a portion of a vehicle, and
a pivoting assembly connected to said hydraulic cylinder and configured to pivot said hydraulic cylinder between a vertical active position and a horizontal storage position,
a hydraulic pump system operatively connected to said hydraulic cylinders; and
a control arrangement configured to be installed in a cab of a flatbed tow truck and operatively connected to said anchor assemblies and said hydraulic pump system to permit a driver to remotely operate said anchor assemblies.

2. The hydraulic tow truck anchor system of claim 1, wherein said engagement head comprises a hook and said hydraulic cylinder is configured to extend and retract said hook to clamp onto an axle of a vehicle with sufficient force to hold the vehicle in place on a bed of a flatbed tow truck.

3. The hydraulic tow truck anchor system of claim 2, wherein said hook is pivotably connected to said piston.

4. The hydraulic tow truck anchor system of claim 2, wherein said pivoting assembly comprises a telescoping arm that is extendable and retractable or a fixed arm.

5. The hydraulic tow truck anchor system of claim 4, wherein each of said anchor assemblies comprises a mounting bracket attachable to a bed of a flatbed tow truck, wherein said hydraulic cylinder is pivotably attached to said mounting bracket.

6. The hydraulic tow truck anchor system of claim 5, wherein each of said anchor assemblies comprises a guide track and drive arrangement mountable in a bed of a flatbed tow truck and operatively connected to said hydraulic cylinder and said pivoting assembly to permit selective adjustment of a position of said hydraulic cylinder on the bed.

7. The hydraulic tow truck anchor system of claim 6, wherein said control arrangement is operatively connected to said guide track and drive to permit a driver to remotely operate said guide track and drive arrangement.

8. The hydraulic tow truck anchor system of claim 2, wherein said control arrangement comprises a camera mountable on a bed of a flatbed tow truck and a video screen mountable in a cab of a flatbed tow truck and operatively connected to said camera to permit viewing of said anchor assemblies.

9. The hydraulic tow truck anchor system of claim 2, wherein said control arrangement is operatively connected to a tow trolley to permit a driver to remotely operate said tow trolley to pull a vehicle up onto a bed of a flatbed tow truck.

10. The hydraulic tow truck anchor system of claim 1, wherein said engagement head comprises a metal plate and said hydraulic cylinder is configured to extend and retract said metal plate to place said metal plate against a surface of a wheel of a vehicle with sufficient force to hold the vehicle in place on a bed of a flatbed tow truck.

11. The hydraulic tow truck anchor system of claim 10, wherein said engagement head comprises a rubber layer to cushion said metal plate.

12. The hydraulic tow truck anchor system of claim 11, wherein said engagement head is pivotably connected to said piston.

13. A hydraulic tow truck anchor system comprising:
a plurality of anchor assemblies configured to be mounted to a bed of a flatbed tow truck and detachably connect to a portion of a vehicle to temporarily secure the vehicle to the bed, wherein:
each of said anchor assemblies comprises:
a hydraulic cylinder and piston,
an engagement head attached to and movable by said piston to place said piston in a securing engagement with a portion of a vehicle, and
a pivoting assembly connected to said hydraulic cylinder and configured to pivot said hydraulic cylinder between a vertical active position and a horizontal storage position,
one of (A) and (B):
(A) said engagement head comprises a hook and said hydraulic cylinder is configured to extend and retract said hook to clamp onto an axle of a vehicle with sufficient force to hold the vehicle in place on a bed of a flatbed tow truck,
said hook is pivotably connected to said piston, and
(B) said engagement head comprises a metal plate and said hydraulic cylinder is configured to extend and retract said metal plate to place said metal plate against a surface of a wheel of a vehicle with sufficient force to hold the vehicle in place on a bed of a flatbed tow truck,
said engagement head comprises a rubber layer to cushion said metal plate,
said engagement head is pivotably connected to said piston,
said pivoting assembly comprises a telescoping arm that is extendable and retractable or a fixed arm,
each of said anchor assemblies comprises a mounting bracket attachable to a bed of a flatbed tow truck, wherein said hydraulic cylinder is pivotably attached to said mounting bracket,
each of said anchor assemblies comprises a guide track and drive arrangement mountable in a bed of a flatbed tow truck and operatively connected to said hydraulic cylinder and said pivoting assembly to permit selective adjustment of a position of said hydraulic cylinder on the bed;
a hydraulic pump system operatively connected to said hydraulic cylinders; and
a control arrangement configured to be installed in a cab of a flatbed tow truck and operatively connected to said anchor assemblies and said hydraulic pump system to permit a driver to remotely operate said anchor assemblies, wherein:
said control arrangement is operatively connected to said guide track and drive arrangement to permit a driver to remotely operate said guide track and drive arrangement,
said control arrangement comprises a camera mountable on a bed of a flatbed tow truck and a video screen mountable in a cab of a flatbed tow truck and operatively connected to said camera to permit viewing of said anchor assemblies,
said control arrangement is operatively connected to a tow trolley to permit a driver to remotely operate said tow trolley to pull a vehicle up onto a bed of a flatbed tow truck.
